(19) United States
(12) Patent Application Publication
(10) Pub. No.: US 2006/0292314 A1
(43) Pub. Date: Dec. 28, 2006

(54) Coating liquid for coating a retardation film, retardation film and composite polarizing plate using the coating liquid and method for producing retardation film, and liquid crystal display device

(75) Inventors: Kenji Yamada, Ehime (JP); Tohru Nagashima, Ehime (JP); Yoshiki Matsuoka, Ehime (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 11/425,397

(22) Filed: Jun. 21, 2006

(30) Foreign Application Priority Data
Jun. 24, 2005 (JP) 2005-184626
Aug. 3, 2005 (JP) 2005-225043

(51) Int. Cl. C09K 19/00

(52) U.S. Cl. 428/1.31

(57) ABSTRACT

The invention provides a coating liquid containing an organic modified clay complex, being able to reduce the haze value when formed into a coating retardation film and to maintain a high contrast ratio of the liquid crystal display device. The coating liquid is formed into a retardation film and composite polarizing plate, and the composite polarizing plate is applied to a liquid crystal device. The invention also provides a coating liquid for coating a retardation film containing an organic modified clay complex and a binder resin in an organic solvent and having a moisture content in the range from 0.15 to 0.35% by weight as measured with a Karl Fischer moisture meter. A retardation film is formed from the coating liquid for coating the retardation film by forming a composition obtained by removing the organic solvent and water from the coating liquid into a film. A composite polarizing plate is prepared by laminating the polarizing plate, adhesive layer and retardation film in this order. A liquid crystal display device is produced by disposing this composite polarizing plate at one surface of a liquid crystal cell, and another retardation film and polarizing plate on the other surface of the liquid crystal cell.

### BACKGROUND OF THE INVENTION

1. Field of the Invention

The invention relates to a coating liquid for coating a retardation film, retardation film and composite polarizing plate using the coating liquid and method for producing thereof retardation film, retardation film retardation film and liquid crystal display device.

2. Description of the Related Art

Liquid crystal display devices that consume less electric power, can be addressed by a low voltage and are thin and lightweight have been rapidly spread as information display devices for portable phones, portable information terminals, computer monitors and televisions. Various modes of liquid crystal display devices have been proposed in accordance with the progress of liquid crystal technologies, and problems of the liquid crystal display device such as response rate, contrast and narrow angle of view are being solved. However, it is pointed out that the angle of view of the liquid crystal display device is yet narrower than that of cathode ray tubes, and various attempts have been made to expand the angle of view.

As an example of the method for improving such characteristics of the angle of view described above, Japanese Patent Publication No. 2,548,979 has disclosed development of a nematic liquid crystal display device of a vertical orientation mode (VA-LCD). Since such vertical orientation mode permits liquid crystal molecules to vertically orient to a base material in a non-addressed state, the light permeates the liquid crystal layer without accompanying any changes of polarized light. Consequently, almost perfect black display may be obtained in the front view with a high contrast ratio by disposing linearly polarizing plates so that polarization axes of upper and lower liquid crystal panels are perpendicular to one another.

However, the contrast ratio is remarkably lowered due to leak of the light in the liquid crystal display device of the vertical orientation mode comprising only the polarizing plates on the liquid crystal cell, since the angle between the axes of the disposed polarizing plates is shifted from 90° when viewed aslant, and rod-like liquid crystal molecules in the cell exhibit birefringence.

For solving the problem of leak of the light, an optical compensation film should be inserted between the liquid crystal cell and linearly polarizing plate. In specifications of conventional liquid crystal display devices, each one of two biaxial retardation films have been inserted between the upper polarizing plate and liquid crystal and between the liquid crystal and lower polarizing plate, respectively, or each one of a uniaxial retardation film and a completely biaxial polarizing plate have been placed on the top and bottom of the liquid crystal cell, or both polarizing plates have been placed at one side of the liquid crystal cell. For example, Japanese Patent Application Laid-Open (JP-A) No. 2001-109009 discloses a liquid crystal display device of the vertical orientation mode, wherein a-plate (a positive uniaxial retardation film) and c-plate (a perfectly biaxial retardation film) have been inserted between the upper polarizing plate and liquid crystal cell and between the lower polarizing plate and liquid crystal cell, respectively.

The positive uniaxial retardation film means a film having an in-plane phase difference value R₀ and a phase difference value R′ in the direction of thickness with a ratio R0/R′ of approximately 2, while the perfectly biaxial retardation film means a film having an in-plane phase difference value R₀ of approximately zero. The in-plane phase difference value R₀ and the phase difference value R′ in the direction of thickness are defined by equations (I) and (II) below, respectively, where nₓ denotes a refractive index of an in-plane slow axis of the film, n_{y} denotes a refractive index of an in-plane fast axis (the axis perpendicular to the direction of the slow axis) of the film, n_{z} denotes a refractive index in the direction of thickness of the film, and d denotes the thickness of the film:
R₀=(nₓ−n_{y})×d (I)
R′=[(nₓ+n_{y})/2−n_{z}]×d (II)

Since n_{z} is approximately equal to n_{y} in the positive uniaxial film, R₀/R′ is approximately equal to 2. However, R₀/R′ changes in the range from about 1.8 to about 2.2 depending on draw conditions even in the uniaxial film. Since nₓ is approximately equal to n_{y} in the perfectly biaxial film, R₀ is approximately zero. The perfectly biaxial film is a negative uniaxial film and is called as a film having an optical axis in the direction of the normal line, since only the refractive index in the direction of thickness is different (small). Or, the film may be called as c-plate as described above. The relation of nₓ>n_{y}>n_{z} is valid in the biaxial film.

JP-A No. 10-104428 (U.S. Pat. No. 6,060,183) has disclosed to form the retardation film with a coating layer containing an organic modified clay complex dispersible in an organic solvent as the perfectly biaxial retardation film used for the above-mentioned objects. The composite polarizing plate, which is formed by laminating the retardation films comprising the coating layers on a polarizing plate in a given manner, has a simple structure, and both excellent characteristics of the angle of view and simplicity of the structure may be attained when it is applied to the liquid crystal display device. JP-A No. 2004-294983 has disclosed a polarizing plate integrated with a retardation film at one side of a polarizer, wherein the polarizing plate comprises a layer of a composition containing the organic modified clay complex dispersible in an organic solvent and (meth)acrylate resin.

However, when a composite polarizing plate is formed by laminating a retardation film formed of a coating layer containing such organic modified clay complex on a polarizing plate, and when the composite polarizing plate is applied to the liquid crystal display device, the retardation film may be depolarized due to haze arising from the retardation film to decrease the contrast ratio. Alternatively, when a retardation film formed of a coating layer containing the organic modified clay complex, or a composite retardation film laminated on a polarizing plate, is bonded to a cell glass of the liquid crystal display device with interposition of an adhesive, the adhesive force to the glass of the liquid crystal cell may be decreased with time due to the nature of the retardation film.

The inventors of the invention have found, through intensive studies for solving the above-mentioned problems, that haze of the carting retardation film can be suppressed by adjusting the moisture content of the coating liquid for coating the retardation film, which contains the organic modified clay complex and binder resin in an organic solvent, to a specified value. It was also found that the adhesive force of the carting retardation film when bonded to the glass of the liquid crystal cell can be suppressed from decreasing by reducing the content of chlorine in the organic modified clay complex used in the coating liquid for coating the retardation film below a predetermined value. The invention has been completed based on these discoveries.

### SUMMARY OF THE INVENTION

Accordingly, it is an object of the present invention to provide a coating liquid that contains an organic modified clay complex, is able to reduce the haze value when formed into the carting retardation film, and is able to maintain a high contrast ratio of the liquid crystal display device. Another object of the invention is to provide a coating liquid for coating the retardation film that is able to maintain a high adhesive force when the carting retardation film is bonded to the glass of the liquid crystal cell with interposition of an adhesive. A different object of the invention is to provide a retardation film improved in the haze value using the coating liquid and a method for producing the retardation film. A further different object of the invention is to provide a composite retardation film comprising the retardation film laminated on the polarizing plate and being effective for improving characteristics of the angle of view of the liquid crystal display device, and a method for producing the composite polarizing plate. A further different object of the invention is to provide a liquid crystal display device being improved in characteristics of the angle of view and having a high contrast ratio by combining the composite polarizing plate with the liquid crystal cell.

Accordingly, the invention provides a coating liquid for coating a retardation film containing an organic modified clay complex and a binder resin in an organic solvent, wherein the moisture content in the coating liquid is in the range from 0.15 to 0.35% by weight as measured with a Karl Fischer moisture meter.

The weight ratio of the organic modified clay complex to the binder resin is preferably in the range exceeding 0.5 to 3 or less. The binder resin is preferably an aliphatic diisocyanate-base urethane resin, for example an isophorone diisocyanate-base urethane resin. When the organic modified clay complex is a complex between an organic compound and a clay mineral belonging to smectite groupsmectite group, the atomic ratio of magnesium to four silicon atoms (Mg/Si₄) is preferably less than 2.73. More preferably, the organic modified clay complex is a complex between a quaternary ammonium compound having alkyl groups with a carbon number in the range from 1 to 30 and a clay mineral belonging to smectite group.

It is advantageous in this coating liquid to adjust the content of chlorine therein to 2,000 ppm or less. Reducing the content of chlorine in the organic modified clay complex permits the adhesive force of the carting retardation film to be less reduced when it is bonded to the glass of the liquid crystal cell with interposition of the adhesive.

The invention also provides a retardation film prepared by forming a composition in which an organic solvent and water are removed from any one of the coating liquids for coating the retardation film described above into a film.

The retardation film preferably has a haze value of 0.6% or less. Preferably, the retardation film has an in-plane phase difference value R₀ in the range from 0 to 10 nm, and a phase difference value R′ in the direction of thickness in the range from 40 to 350 nm.

The retardation film may be produced by the steps comprising: coating a coating liquid containing an organic modified clay complex, a binder resin, an organic solvent and water with a moisture content in the range from 0.15 to 0.35% by weight as measured with a Karl Fischer moisture meter on a base material; and removing the organic solvent and water.

The invention also provides a composite polarizing plate comprising a polarizing plate, an adhesive layer and any one of the retardation films described above laminated in this order. The composite polarizing plate may comprise a second adhesive layer formed at the outside of the retardation film.

The composite polarizing plate may be advantageously produced by the steps comprising: coating a coating liquid, which contains an organic modified clay complex and a binder resin in an organic solvent and has a moisture content in the range from 0.15 to 0.35% by weight as measured with a Karl Fischer moisture meter, on a transfer base material; forming a carting retardation film by removing the organic solvent and water from the coating liquid; bonding an exposed surface of the carting retardation film to an adhesive layer side of a polarizing plate having the adhesive layer; and peeling the transfer base material from the carting retardation film.

The invention also provides a liquid crystal display device comprising the composite polarizing plate and a liquid crystal cell. The composite polarizing plate is disposed on one surface of the liquid crystal cell so that the retardation film side of the composite retardation film faces the liquid crystal cell, or so that the retardation film rather than the polarizing plate comes to the liquid crystal side. When a second adhesive layer is formed at the outside of the retardation film, the composite polarizing plate is bonded to the liquid crystal cell with interposition of the second adhesive layer. Characteristics of the angle of view may be improved by laminating a second retardation film, which has an in-plane phase difference value R₀ in the range form 30 to 300 nm and a ratio R₀/R′ between the in-plane phase difference value R₀ and a phase difference value R′ in the direction of thickness in the range from exceeding 0 to less than 2, and a second polarizing plate on the other surface of the liquid crystal cell in this order.

The coating liquid for coating the retardation film of the invention enables the haze value of the retardation film produced using the coating liquid to be controlled at a small value. Reducing the content of chlorine contained in the organic modified clay complex used as a component of the coating liquid permits the adhesive force to be suppressed from being lowered with time when the retardation film produced from the organic modified clay complex is bonded to the glass of the liquid crystal cell with interposition of the adhesive. The composite polarizing plate produced by laminating the retardation film and polarizing plate has a thin and simple structure as well as excellent optical characteristics. When the composite polarizing plate is disposed on one surface of the liquid crystal cell while a retardation film (the second retardation film) having different optical characteristics as well as a second polarizing plate are disposed on the other surface of the liquid crystal cell, a liquid crystal display device having optical performance comparable or superior to those of conventional liquid crystal display devices of a vertical orientation mode having biaxial retardation films on the upper and lower surfaces, respectively, may be obtained. The adhesive force of the adhesive for bonding the liquid crystal cell to the carting retardation film may be maintained by using a coating liquid prepared from the organic modified clay complex in which the content of chlorine is reduced.

### BRIEF DESCRIPTION OF THE DRAWINGS

FIGS. 1A and 1B are schematic cross sections showing an example of construction of the composite polarizing plate according to the invention;

FIGS. 2A to 2E illustrate schematic cross sections of an example of the production process of the composite polarizing plate;

FIG. 3 is a side view illustrating the steps from forming the carting retardation film to bonding the polarizing plate with an adhesive when the composite polarizing plate is produced as a roll;

FIG. 4 is a side view illustrating the step for forming the second adhesive layer on the composite polarizing plate;

FIG. 5 is a side view illustrating continuous steps from forming the coating retardation film to forming the second adhesive layer; and

FIG. 6 is a schematic cross section showing an example of construction of the liquid crystal display device according to the invention.

### DESCRIPTION OF THE PREFERRED EMBODIMENTS

The invention will be described in detail. The coating liquid for coating the retardation film will be described first. The coating liquid for coating the retardation film contains an organic modified clay complex and a binder resin in an organic solvent. For obtaining such coating liquid, it is preferable to disperse or dissolve the organic modified clay complex and binder resin in an organic solvent.

The moisture content of the coating liquid for coating the retardation film is adjusted in the range from 0.15 to 0.35% by weight in the invention. The coating liquid tends to be separated into two layers by phase separation in a non-water soluble organic solvent when the moisture content exceeds 0.35% by weight. On the other hand, the haze value tends to be increased when a coating retardation film is formed when the moisture content is less than 0.15% by weight. Accordingly, it is more preferable to adjust the moisture content to 0.18% by weight or more, or in the range from 0.2% by weight or more to 0.3% by weight or less. While the moisture content is measured by a drying method, Karl Fischer method or dielectric method, the Karl Fisher method is used in the invention since the method is simple and convenient while a minute quantity of moisture can be measured.

While the method for adjusting the moisture content of the coating liquid for coating the retardation film is not particularly restricted, it is simple and desirable to add water in the coating liquid. The coating liquid seldom exhibits a moisture content of 0.15% by weight or more merely by mixing the organic solvent, organic modified clay complex and binder resin used in the invention by a usual method. However, the moisture content may be about 15% by weight when a material swelled with moisture in the summer season is used. It is difficult, however, to sufficiently reduce the haze value of the coating retardation film even by using a coating liquid having a moisture content of about 15% by weight due to absorbed moisture in the material. Accordingly, it is preferable to adjust the moisture content in the range as described above by adding a small amount of water to the coating liquid in which the organic solvent, organic modified clay complex and binder resin are mixed. While the method for adding water is not particularly restricted since addition of water at an arbitrary time of the coating liquid preparation step is effective, it is preferable for obtaining good reproducibility and for precisely controlling the moisture content to add a predetermined amount of water by measuring the moisture content by sampling the liquid after a given length of time lapse during the step for preparing the coating liquid. While the amount of added water may happen to be different from the result of measurement with the Karl Fischer moisture meter, the cause thereof may be conjectured that a part of water interacts with the organic modified clay complex (for example adsorbed on the clay complex). However, it has been confirmed that the haze value of the coating retardation film obtained may be suppressed by maintaining the moisture content measured with the Karl Fischer moisture meter in the range from 0.15 to 0.35% by weight, preferably from 0.18 to 0.3% by weight, and more preferably in the range from 0.2 to 0.3% by weight, that are prescribed in the invention.

The organic modified clay complex and binder resin are preferably blended in a weight ratio of the former to the latter in the range from exceeding 0.5 to 3 or less. The haze value of the coating retardation film obtained tends to be difficult to maintain at a desirable level when the weight ratio of blending of both components is out of the range described above. The blending ratio of both components is preferably adjusted in the range from 1 to 3, particularly in the range form exceeding 1 to 2 or less.

While the concentration of the solid fraction in the coating liquid is not particularly restricted unless the coating liquid after preparation is not gelled or does not become cloudy in a practically permissible range, the coating liquid is usually used in a concentration range from about 3 to about 18% by weight as a concentration of the combined solid fraction of the organic modified clay complex and binder resin. While the optimal concentration of the solid fraction is determined for respective compositions since the optimum concentration is different depending on the kinds and composition ratio of the organic modified clay complex and binder resin, it is preferably in the range from 8 to 16% by weight. Various additives such as a viscosity controlling agent for improving applicability for forming a film on the substrate and a cross-linking agent for further improving hydrophobicity and/or hydrophilicity may be added to the coating liquid.

While the organic solvent used for the coating liquid is not particularly restricted, examples of the solvent available include less polar aromatic hydrocarbon solvents such as benzene, toluene and xylene; ketones such as acetone, methylethyl ketone and methylisobutyl ketone; lower alcohols such as methanol, ethanol and propanol; and more polar solvents including halogenated hydrocarbons such as carbon tetrachloride, chloroform, dichloromethane and dichloroethane. Toluene, xylene, acetone and methylisobutyl ketone, and a mixture thereof are preferable among them since these solvents are able to dissolve the binder resin while the coating liquid is prevented from being gelled.

While the binder resin is not particularly restricted so long as it is soluble in the organic solvents described above, the solvent is desirably hydrophobic for attaining good heat stability and handling performance. Examples of the preferable binder resin include polyvinyl acetal resins such as polyvinyl butyral and polyvinyl formal; cellulose resins such as cellulose acetate butylate; acrylic resins such as butyl acrylate; methacrylic resins; urethane resins; epoxy resins; and polyester resins. Urethane resins comprising aliphatic diisocyanate as a base resin is preferable among them.

The aliphatic diisocyanate-base urethane resin is formed by an addition reaction of an aliphatic compound having a plurality of isocyanate groups in the molecule with a compound having a plurality of active hydrogen atoms in the molecule. Examples of the aliphatic compound having a plurality of isocyanate groups in the molecule include hexamethylene diisocyanate, dicyclohexylmethane diisocyanate, cyclohexene diisocyanate, hydrogenated xylylene diisocyanate, isophorone diisocyanate and norbornene diisocyanate. Resins based on isophorone diisocyanate are particularly preferable among them.

Examples of the compound having a plurality of hydroxyl groups in the molecule include polyether polyol, polyester polyol, polycarbonate polyol and polycaprolactone polyol. While polyether polyol and polyester polyol are preferably used among them, the compound is not restricted thereto, and mixtures of them may be used.

Polyether polyol is produced, for example, by ring opening polymerization or copolymerization of cyclic ethers such as ethylene oxide, propylene oxide, trimethylene oxide, butylene oxide, a-methyltrimethylene oxide, 3,3-dimethyltrimethylene oxide and tetrahydrofuran and dioxane, and is also named as polyether glycol or polyoxyalkylene glycol.

Polyester polyol is produced by condensation polymerization of polybasic organic acids, particularly dicarboxylic acids, with polyols. Examples of dicarboxylic acid include saturated aliphatic acids such as oxalic acid, succinic acid, glutaric acid, adipic acid, pimelic acid, suberic acid, azelaic acid, sebacic acid and isosebacic acid; unsaturated aliphatic acids such as maleic acid and fumaric acid; and aromatic carboxylic acid such as phthalic acid and isophthalic acid. Examples of polyol include diols such as ethyleneglycol, diethyleneglycol, triethyleneglycol, propyleneglycol and butyleneglycol; triols such as trimethylol propane, trimethylol ethane, hexane triol and glycerin; and hexaol such as sorbitol. However, polyols are not restricted thereto, and may be used as a mixture of at least two of them.

The binder resin preferably has a glass transition temperature of 20° C. or less, more preferably −20° C. or less. Rubber elasticity is insufficient when the glass transition temperature of the binder resin is high, and adhesiveness and flexibility tend to be poor in the retardation film and composite polarizing plate comprising the retardation film laminated on the polarizing plate.

The organic modified clay complex is a composite of an organic compound and a clay mineral, specifically a composite between a clay mineral having a lamellar structure and an organic compound. Examples of the clay mineral having the lamellar structure include smectite group and swellable mica, and these clay minerals can form a composite with the organic compound by their ion-exchange ability. The smectite group are favorably used among the clay minerals since they are excellent in transparency. Examples of the clay minerals belonging to the smectite group include hectorite, montmorillonite and bentonite, and substituted or derivatized products and mixtures thereof. Chemically synthesized clay minerals are preferable among them since they contain fewer impurities and are excellent in transparency. The synthetic hectorite controlled to have a small particular diameter is preferably used since scattering of visible light is suppressed.

The organic compound that can be compounded with the clay mineral is a compound capable of reacting with the oxygen atom and hydroxyl group of the clay mineral, or an ionic compound capable of being exchanged with exchangeable cations of the clay mineral. While the organic compound is not particularly restricted so long as the organic modified clay complex is made to be swellable or dispersible in the organic solvent, specific examples of the organic compound are nitrogen-containing compounds. Examples of the nitrogen-containing compound include primary, secondary or tertiary amines, quaternary ammonium compounds, urea and hydrazine. The quaternary ammonium compound is preferable among them since it is readily exchanged with cations in the clay mineral.

Examples of the quaternary ammonium compound include those having long chain alkyl groups and alkyl ether chains. Quaternary ammonium compounds having alkyl groups with a carbon number of 1 to 30, or —(CH₂CH(CH₃)O)ₙH or —(CH₂CH₂CH₂O)ₙH groups with n of 1 to 50 are preferable among them. The quaternary ammonium compounds having a carbon number in the range from 6 to 10 are more preferable.

When the organic modified clay complex is constructed with an organic compound and a clay mineral belonging to smectite group, the clay mineral belonging to smectite group is not particularly restricted so long as the complex with the organic compound is swellable with or dispersible to the organic solvent as a complex. However, clay minerals containing exchangeable cations hardly exchangeable with ionizable organic compounds can be hardly dispersed in the organic solvent. Since magnesium compounds such as magnesium hydroxide are often adhered on the surface of synthetic clay minerals belonging to smectite group, such magnesium compounds contained in a large quantity may block exchangeable cationic site. Accordingly, clay minerals from which the abundance ratio of magnesium is reduced by removing surface magnesium by washing with an acid, specifically clay minerals having an atomic ratio of magnesium to four silicon atoms (Mg/Si₄) of less than 2.73, are preferable since the clay mineral is readily dispersed in the organic solvent. For example, hectorite belonging to the smectite group is typically represented by a composition formula of Na_{0.66}(Mg_{5.34}Li_{0.66})Si₈O₂₀(OH)₄.nH₂O or Na_{1/3}(Mg_{8/3}Li_{1/3})Si₄O₁₀(OH)₂ .mH₂O as described in “Kagaku Daijiten (Dictionary of Chemistry)”, edited by Editorial Board of Kagaku Daijiten, Kyoritsu Shuppan Co., Feb. 28, 1962. While the atomic ratio (Mg/Si₄) of hectorite represented by the composition formula above is 2.67, the atomic ratio (Mg/Si₄) of synthetic hectorite is slightly larger than 2.67 due to the presence of magnesium compounds on the surface.

The magnesium compound present on the surface is removed by washing with an acid, and the Mg/Si₄ ratio is adjusted to be as close as 2.67 in the preferably used clay mineral. Sodium serves as an exchangeable cation in the smectite group including hectorite and synthetic hectorite, and the sodium ion is exchanged with an organic compound, for example ternary ammonium group, to form an organic modified clay complex. Consequently, the Mg/Si₄ ratio never changes before and after the modification. Accordingly, it is effective to wash the clay mineral with an acid before modifying with an organic compound for adjusting the Mg/Si₄ atomic ratio of the organic modified clay complex to be less than 2.73.

Two or more kinds of the organic modified clay complexes may be used in combination. Examples of suitable commercially available organic modified clay complex include composites of synthetic hectorite and ternary ammonium compound sold by CO-OP Chemical Co. under the trade names of Lucentite STN and Lucentite SPN.

The organic modified clay complex is often mingled with compounds containing chlorine as impurities. The clay mineral complex may bleeds out of the film after forming into the coating retardation film when the content of the chlorine compound is large. Then, the adhesive force may be largely decreased with time when the coating retardation film is bonded to the glass of the liquid crystal cell with interposition of an adhesive. Accordingly, the chlorine compound is preferably removed from the organic modified clay complex by washing, and the adhesive force may be prevented from decreasing by reducing the amount of chlorine contained in the clay complex to 2,000 ppm or less. The chlorine compound can be removed by washing the organic modified clay mineral with water.

When the coating liquid obtained by mixing the organic modified clay complex, binder resin and a small amount of water in an organic solvent contains solids having a large particle diameter, the coating retardation film prepared from the coating liquid may exhibit a depolarization function, and causes a decrease of optical performance of the liquid crystal display device produced using the coating liquid. While the particle diameter of the organic modified clay complex may be fined by deflocculation by stirring the coating liquid, optical performance may be also decreased when deflocculation is imperfect and particles with a larger particle diameter, for example 1 μm or more, are left behind. Accordingly, it is desirable to filter the coating liquid in order to remove such solid fraction that may possibly exist. However, deflocculated organic modified clay complex should not be removed by this filtration process. Since the filter is expected to be able to remove almost all the solids with a particle diameter of 1 μm or more, the filter is preferably selected from those having a pore diameter in the range from 0.5 to 10 μm by taking the changes of filtratable particle diameter by clogging into consideration, so that almost all the solids with a particle diameter of 1 μm or more can be removed. The particle diameter of the organic modified clay complex after deflocculation is in the range from about 10 to 200 nm.

The retardation film and the method for producing the same will be then described. The retardation film can be obtained by applying a coating liquid as described above, which contains the organic modified clay complex, binder resin, organic solvent and water and has a moisture content adjusted within a specified range, on a flat substrate, followed by removing the organic solvent and water. The Mg/Si₄ atomic ratio of the organic modified clay complex is preferably adjusted to be less than 2.73, while the content of chlorine contained in the clay complex is preferably adjusted to be 2,000 ppm or less. The organic solvent and water are usually removed by drying after coating. The retardation film of the invention is formed into a film of the composition obtained by removing the organic solvent and water from the coating liquid. The retardation film is provided as a film itself comprising the composition, or as a film of the composition coated on a base material.

The lamellar structure of the unit crystal layer of the organic modified clay complex is oriented to be parallel to the flat surface of the base material by coating and drying as described above, while the crystals of the organic modified clay complex are randomly oriented in the plane. Accordingly, the in-plane refractive index of the film becomes larger than the refractive index in the direction of thickness without applying any special orientation treatment.

While the base material for applying the coating liquid is not particularly restricted, an example is a polyethylene terephthalate film subjected to a release treatment. While the temperature and time for drying the coating film is not particularly restricted so long as the temperature and time are sufficient for removing the organic solvent and water used, they may be appropriately selected from the temperature range from 50° C. to 150° C. and time range from 30 seconds to 30 minutes.

The retardation film of the invention preferably has a haze value of 0.6% or less, more preferably 0.5% or less. Depolarization may occur due to scattering of transmitting linearly polarized light when the haze value exceeds 0.6%, and the contrast of the liquid crystal display device using the retardation film may be decreased. The haze value is also referred to a cloud value defined by (diffusion transmission/total transmission)×100, which is prescribed in JIS K7105. The haze value may be reduced by applying the coating liquid in which the moisture content is adjusted within a specified range, and drying the applied film.

The retardation film preferably has an in-plane phase difference value R₀ in the range from 0 to 10 nm, and a phase difference value R′ in the direction of thickness in the range form 40 to 350 nm. The in-plane phase difference value R₀ cannot be ignored when the value is larger than 10 nm, and negative uniaxiality is impaired. While the phase difference value R′ in the direction of thickness may be appropriately selected depending on the use of the retardation film, particularly on the characteristics of the liquid crystal cell used by bonding the composite polarizing plate, the value is particularly in the range from 50 to 300 nm. The phase difference value R′ in the direction of thickness is adjusted in the range from abut 50 to about 200 nm in most cases, although the value depends on the kind of the liquid crystal cell. The phase difference value R′ in the direction of thickness can be controlled by the thickness of the applied coating liquid. Accordingly, the thickness of the film for forming the dried retardation film is not particularly restricted, and the film may have a thickness necessary for realizing a phase difference value Required for the retardation film.

Anisotropy of the refractive index in the direction of thickness is represented by the phase difference value R′ in the direction of thickness defined by equation (II) above. This value can be calculated from a phase difference value R₄₀ measured by tilting the in-plane slow axis at a tilt angle of 40 degree as an inclined axis, and in-plane phase difference value R₀.

For determining the phase difference value R′ in the direction of thickness from equation (II) is calculated by substituting nₓ, n_{y} and n_{z} into equation (II), nₓ, n_{y} and n_{z} are determined from following equations (III) to (V) using the phase difference value R₄₀ measured by tilting the slow axis as the inclined axis at a tilt angle of 40 degree, film thickness d and average refractive index no of the film, difference value R:
R₀=(nₓ−ny)×d (III)
R40=(nₓ−n_{y}′)×d/cos(F) (IV)
(nₓ+n_{y}+n_{z})/3=n0 (V)
where
F=sin⁻¹[sin(40°)/n₀]
n_{y}′=n_{y}×n_{z}/[ny²×sin²(F)+n_{z}²×cos²(F)]^{1/2}

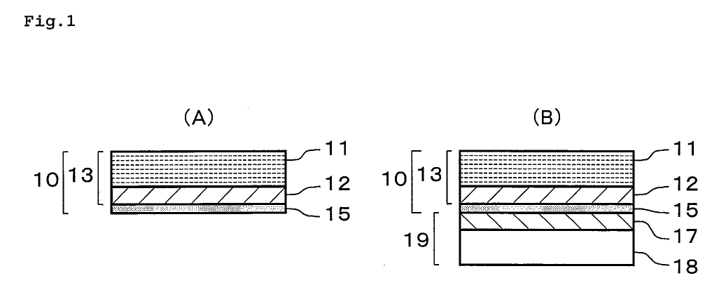

The composite polarizing plate will be then described. As shown in FIG. 1A, the composite polarizing plate of the invention comprises a polarizing plate 11, an adhesive layer 12 and the retardation film 15 as described above laminated in this order. The polarizing plate 11 and the adhesive layer 12 are prepared as a polarizing plate 13 with an adhesive. A retardation film 15 comprises the coating layer having an anisotropic refractive index as described above. This coating layer may be composed of a monolayer, or a multi-layer comprising two or more layers.

The composite polarizing plate 10 is usually used by being bonded to the liquid crystal cell so that the retardation film 15 comes to the liquid crystal side, or so that the polarizing plate 11 comes outside. Accordingly, a second adhesive layer 17 may be provided at the outside of the retardation film 15 as shown in FIG. 1B. A release film 18 is further provided at the outside of the second adhesive layer 17, and the release film 18 is removed by peeling before bonding the composite polarizing plate to the liquid crystal cell at the surface of the second adhesive layer 17. Otherwise, a film 19 with an adhesive having the adhesive layer 17 on the release film 18 may be provided in order to laminate the film 19 on the coating retardation film 15 at the adhesive layer 17 side.

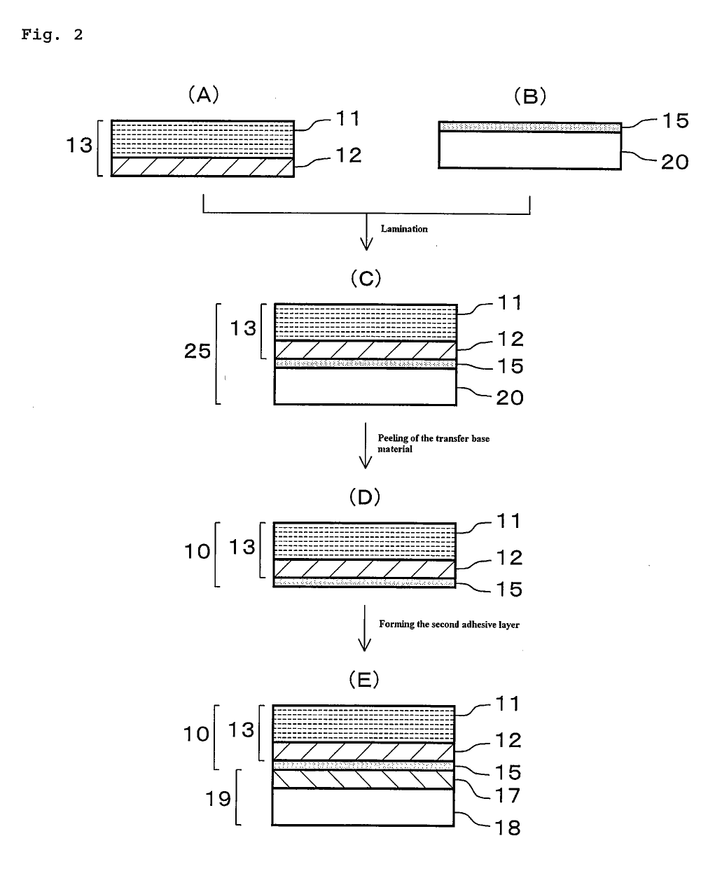

The composite polarizing plate of the invention can be formed by forming the coating retardation film 15 on a transfer base material, followed by transferring the coating retardation film onto the surface of the adhesive layer 12 of the polarizing plate 13 with the adhesive. The method will be described with reference to FIG. 2.

As shown in FIG. 2A, the polarizing plate 13 with an adhesive in which the adhesive layer 12 is formed on the surface of the polarizing plate 11 is prepared at first. A coating retardation film 15 is separately formed on the surface a transfer base material 20 as shown in FIG. 20B. Then, the adhesive layer 12 of the polarizing plate 13 with an adhesive shown in FIG. 2A and the coating retardation film 15 on the transfer base material 20 shown in FIG. 2B are bonded with the adhesive to form a semi-finished product comprising the polarizing plate 11, adhesive layer 12, coating retardation film 15 and transfer base material 20 as shown in FIG. 2C. The composite polarizing plate 10 shown in FIG. 1A is obtained thereafter by peeling the transfer base material 20 as shown in FIG. 2D. A second adhesive layer 17 and a release film 18 are provided on the surface of the coated retardation film 15 as shown in FIG. 2E to obtain the composite polarizing plate 10 with the adhesive layer 17 as shown in FIG. 1B. The second adhesive layer 17 may be provided by directly applying an adhesive on the coated retardation film 15, or by preparing a film 19 with an adhesive obtained by applying and drying the adhesive on the release film 18 in advance, followed by bonding the adhesive layer 17 side to the coated retardation film 15.

For enhancing respective adhesion between the adhesive layer 12 and coated retardation film 15 and between the coated retardation film 15 and second adhesive layer 17, either of the surfaces of the pair may be subjected to corona treatment.

The polarizing plate 11 used for the composite polarizing plate 11 is not particularly restricted so long as it has a selective permeability against a linearly polarized light having a specified oscillation direction. A specific example thereof is a polyvinyl alcohol resin as a base on which a dichroic pigment is adsorbed and oriented. Iodine or a dichroic organic dye is typically used as the dichroic pigment. Examples of the polarizing plate include a uniaxially drawn polyvinyl alcohol on which iodine molecules are adsorbed and oriented, and a uniaxially drawn polyvinyl alcohol on which a dichroic azo dye is adsorbed and oriented. The polyvinyl alcohol-base polarizer on which the dichroic dye is adsorbed and oriented absorbs a linearly polarized light having an oscillating surface in the direction of orientation of the dichroic pigment, while a linearly polarized light having an oscillating surface perpendicular thereto is permeated.

These polarizing plates are usually used by forming protective layers made of a polymer film such as triacetyl cellulose film on one or both surfaces of the polarizer made of a polyvinyl alcohol film. The protective layer bonded to the liquid crystal cell comes to the outside of the liquid crystal cell when the polarizer has the protective layer on one surface thereof, and the surface having no protective layer is disposed at the adhesive layer 12 side.

Examples of the adhesive used for forming the composite polarizing plate are those using a silicone polymer, polyester, polyurethane or polyether as a base polymer. Preferably used adhesives are selected from those that are excellent in optical transparency, have adequate wettability and cohesive force, are excellent in adhesiveness with the substrate, are excellent in weather resistance and heat resistance, and do not cause problems of floating and peeling under heating and humidifying conditions such as acrylic adhesives. An acrylic copolymer with a weight average molecular weight of 100,000 or more and useful as a base polymer of the acrylic adhesive is prepared by copolymerization by blending a (meth)acrylic acid alkyl ester having an alkyl group with a carbon number of 20 or less such as methyl, ethyl or butyl group and a functional group-containing acrylic monomer comprising (meth)acrylic acid or hydroxyethyl (meth)acrylate so that the glass transition temperature is preferably 25° C. or less, more preferably 0° C. or less. Each of the adhesive layers 12 and 17 usually has a thickness in the range from 15 to 30 μm.

The method for producing the composite polarizing plate according to the invention will be described below. As described previously with reference to FIG. 2, the method preferably comprises the step of forming the coating retardation film 15 having anisotropic refractive index on the transfer base material 20 in advance, followed by transferring the coating retardation film onto the adhesive layer 12 on the polarizing plate 11. Since a step for drying the coating layer on the polarizing plate is not necessary by employing the method described above, the composite polarizing plate may be advantageously produced without causing deterioration of the polarizer by heating or defective coating layer due to insufficient drying.

The transfer base material 20 is a film subjected to a treatment for allowing a layer formed on the substrate to be readily peeled, and examples of the commercially available film are those subjected to a release treatment by applying a release agent such as a silicone resin and fluorinated resin on the surface of a resin film such as polyethylene terephthalate resin. The water contact angle of the transfer base material 20 is preferably in the range from 90 to 130°, more preferably in the range from 100° or more to 120° or less, for forming the coating retardation film 15 on the transfer base material 20. Peelability of the transfer base material 20 becomes poor when the water contact angle is less than 90°, while defects such as irregular phase difference tend to be caused on the coating retardation film 15. When the water contact angle is larger than 130°, on the other hand, the coating liquid before drying is readily repelled on the transfer base material 20 to often generate spotty irregularity of the phase difference on both surfaces. The water contact angle as used herein refers to a contact angle when water is used as a liquid, and a larger value of the contact angle means that the surface is hardly wettable. The upper limit of the water contact angle is 180°.

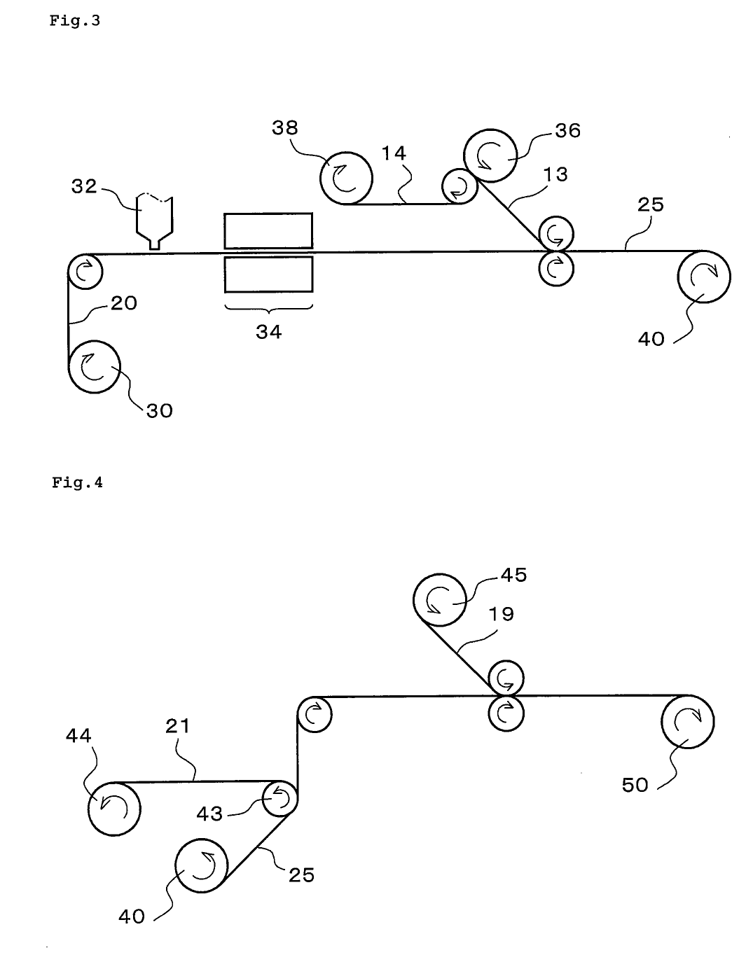

The second adhesive layer 17 may be provided at the outside of the coating retardation film 15 as has been described previously with reference to FIG. 2, particularly FIG. 2E. It is advantageous for forming the second adhesive layer 17 to provide a first step for laminating the exposed surface of the coating retardation film 15 on the adhesive layer 12 of the polarizing plate 11 after forming the coating retardation film 15 on the transfer base material 20, and a second step for forming the second adhesive layer 17 on the peeled surface of the transfer base material of the coating retardation film 15 while the transfer base material 20 is peeled from the coating retardation film 15 laminated on the polarizing plate in this order. The first step was illustrated as a side view in FIG. 3, and the second step was illustrated as a side view in FIG. 4 when the composite polarizing plate is produced as a roll.

In the first step, the coating retardation film having anisotropic refractive index is formed on the transfer base material, the adhesive surface of the polarizing plate is bonded to the surface of the coating retardation film exposed to air, and the bonded plate is rolled. The process will be described in more detail with reference to FIG. 3. The coating liquid for coating the retardation film is applied, through a coater 32, on the surface of the transfer base material 20 drawn out of a transfer base material feed roll 30, and the coated transfer base material is bonded to the polarizing plate 13 with the adhesive after drying by passing through a drying zone 34. Since the polarizing plate 13 with the adhesive is usually supplied by being bonded with a peelable release film on the surface of the adhesive layer, the release film 14 is peeled from the polarizing plate 13 with the adhesive sent from a polarizing plate feed roll 36 at first, and the polarizing plate is wound on a release film winding roll 38. Then, the surface of the polarizing plate 13 with the adhesive on which the adhesive layer is exposed is bonded to the surface of the coating retardation film formed on the transfer base material to form a semi-finish product 25 comprising the polarizing plate, adhesive layer, coating retardation film and transfer base material, and the semi-finish product is wound on a semi-finish product roll 40.

This first step is advantageous with respect to the production cost since the number of production steps is reduced as compared with conventional methods comprising the steps of bonding the protective film onto the surface of the coating retardation film exposed to air, winding the coating retardation film with the protective film on a roll, feeding the film from the roll, and bonding the coating retardation film to the polarizing plate while the protective film is peeled. In addition, a semi-finish product 25 with a quite good quality can be obtained by this first step since defects caused by forced separation for peeling the protective film and due to foreign substances in the protective film are hardly generated. It is a useful technique to wind the semi-finish product so that the surfaces of the semi-finish product do not contact to one another using a side tape in order to prevent the release agent of the transfer base material 20 from being transferred to the coating retardation film by the winding pressure.

While the coating method used for forming the coating retardation film in the first step is not particularly restricted, known coating methods such as a direct gravure method, reverse gravure method, die-coat method, comma coating method and bar-coat method may be used. The comma coat method and die-coat method not using a back-up roll are preferably employed among these methods since the methods are excellent in the precision of thickness.

In the second step thereafter, the adhesive layer is formed on the surface of the coating retardation film after peeling while the transfer base material is peeled from the semi-finish product obtained in the first step, or the semi-finish product is subjected to an adhesive treatment. The step will be described in more detail with reference to FIG. 4. The semi-finish product 25 once wound on the semi-finish product roll 40 in the first step shown in FIG. 3 is supplied from the same roll 40. After peeling the transfer base material 21 at a transfer base material peeling roll 43, the film 19 with the adhesive is supplied from a feed roll 45 so that the film is bonded at the adhesive layer side thereof to the surface of the coating retardation film exposed by peeling. The coating retardation film is bonded to the film with the adhesive, and is wound on a transfer base material winding roll 44. While the film 19 with the adhesive is used for forming the second adhesive layer, the adhesive may be directly applied on the coating retardation film as described above. The composite polarizing plate comprising the polarizing plate, adhesive layer, coating retardation film and adhesive layer laminated in this order is obtained through the steps described above.

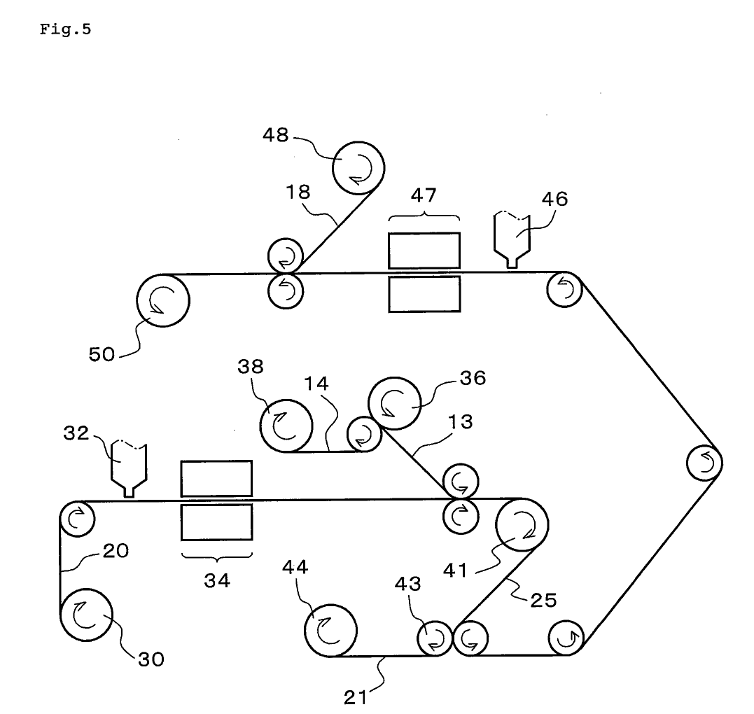

The first step shown in FIG. 3 and the second step shown in FIG. 4 may be combined as a continuous step. An example of this step is illustrated in FIG. 5. In FIG. 5, the same parts as in FIG. 3 or 4 are given the same reference numerals, and detailed descriptions thereof are omitted. A coating liquid for coating the retardation film is applied on the surface of the transfer base material 20 supplied from the transfer base material feed roll 30 in this example and, after drying the coating liquid by passing through the drying zone 34 thereafter, the polarizing plate 13 with the adhesive after peeling the release film 14 by being supplied from the polarizing plate feed roll 36 is bonded to the coating retardation film side at the adhesive layer side to obtain a semi-finish product 25 comprising the polarizing plate, adhesive layer, coating retardation film and transfer base material. This process is the same as step 1 shown in FIG. 3.

The semi-finish product 25 is not wound on the roll thereafter, and the transfer base material is peeled with the transfer base material peeling roll 43 after passing through the semi-finish product winding roll 41, and the transfer base material 21 after being peeled is wound on a winding roll 44. On the other hand, the adhesive is applied on the surface of the coating retardation film after peeling the transfer base material 21 by means of an adhesive coater 46. After drying the adhesive by allowing the coating retardation film to pass through an adhesive drying zone 47, the release film 18 supplied from a release film roll 48 is bonded to the adhesive coating surface of the coating retardation film, and the bonded film is wound on a product roll 50. While the second adhesive layer was formed by a direct coating and drying method using the adhesive coater 46 and drying zone 47 in this example, the film with the adhesive as shown in FIG. 4 may be employed.

When the coating retardation film 15 is left to be in contact with the transfer base material 20 for a long period of time, the release agent on the transfer base material 20 may be transferred to the coating retardation film 15, and the water contact angle on the surface of the coating retardation film 15 may be increased after peeling the transfer base material 20 (the transfer base material after peeling is represented by reference numeral 21). Peeling of the transfer base material and adhesive treatment in the second step are preferably performed under a condition in which the increment of the water contact angle on the surface of the coating retardation film 15 after peeling the transfer base material is within 15°, preferably within 10°, as compared with the contact angle on the surface of the coating retardation film 15 exposed to air when the coating retardation film 15 is formed on the transfer base material 20 (see FIG. 2B) from the view point of adhesiveness between the surface of the coating retardation film 15 after peeling the transfer base material 21 and the second adhesive layer 17. For attaining the condition above, it is preferable to shift the process to the second step as soon as possible after completing the first step. It is a useful technique to apply a corona treatment on the surface of either the coating retardation film 15 or the second adhesive layer 17 for applying the adhesive treatment on the coating retardation film 15 after peeling the transfer base material 21.

The curved arrows in FIGS. 3 to 5 denote the direction of rotation of the roll.

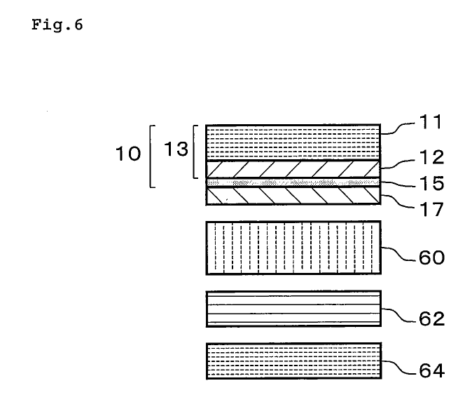

The liquid crystal display device will be then described below. As illustrated as a schematic cross section in FIG. 6, the composite polarizing plate 10 described above is disposed on one surface of a liquid crystal cell 60 at the retardation film 15 side usually with interposition of the second adhesive layer 17, and a second retardation film 62 and second polarizing plate 64 are disposed on the other surface of the liquid crystal cell 60 in this order.

The second retardation film 62 disposed between the liquid crystal cell 60 and second polarizing plate 64 has an in-plane phase difference value R₀ in the range from 30 to 300 nm, and the ratio R₀/R′ between the in-plane phase difference value R₀ and phase difference value R′ in the direction of thickness is in the range from exceeding 0 to less than 2, or 0<R₀<R′<2. Characteristics of the angle of view of the liquid crystal display device can be improved by combining the retardation film having such phase difference characteristics with the composite polarizing plate of the invention described above. The retardation film affording such phase difference characteristics may be produced by uniaxial drawing, specifically by vertical uniaxial drawing, with clumped one edge of an original polymer film using a tenter. The second retardation film 62 preferably has a ratio R₀/R′ in the range from 0.8 to 1.4 for the reason that the retardation film in this range can be readily produced by uniaxial drawing with clumped one edge, and that optical characteristics are excellent when the retardation film is applied to the liquid crystal display device. The ratio R₀/R′ may be 1.3 or less.

The material of the second retardation film 62 is not particularly restricted, and examples thereof may include polycarbonate, polyurethane, cyclic olefin resins using polycyclic olefin such as norbornene as a monomer, cellulose and derivatives thereof, polyolefins, and copolymers using two or more of monomers constituting these polymer compounds. Cyclic olefin resins having a small photoelastic coefficient is preferable from the view point of stability of optical characteristics under a high temperature high humidity condition or under a stress. While wavelength dependency of phase difference of the second retardation film 62 is not particularly restricted, the retardation film preferably has a phase difference distribution so that the phase difference is reduced toward shorter wavelength from the view point of suppressing the apparent coloring of the film.

A protective layer made of a polymer film may be formed on one surface or both surfaces of a polyvinyl alcohol-base polarizer on which a dichroic dye is absorbed and oriented in the second polarizing plate 64 as in the polarizing plate 11 described above with reference to FIG. 1. The protective layer is preferably formed on at least the exposed surface (the surface at the lower side in FIG. 6) of the second polarizing plate 64. The second retardation film 62 may be directly adhered on the polarized of the second polarizing plate 64 using an adhesive or adhesive layer as a substitute of the protective layer at one side of the second polarizing plate 64. The second polarizing plate 64 has the protective layer on only one surface of the linear polarizer in this case, and the second retardation film 62 is laminated at the side of the second polarizing plate having no protective layer.

While the second polarizing plate 64 and second retardation film 62 may be disposed so that the absorption axis of the former intersects the slow axis of the latter at an angle form 80 to 100°, the angle between both axes is preferably in the range form 85 to 95° from the view point of obtaining a high contrast ratio and reducing color blurring. Both plates are more preferably disposed so that the angle between the plates is in the range from 89 to 91°.

Adhesives such as an acrylic adhesive may be used for bonding the second retardation film 62 to the liquid crystal cell, although drawing thereof is omitted. The acrylic adhesive may be also used for bonding the second retardation film 62 to the second polarizing plate 64, particularly when both surfaces of the second polarizing plate 64 has the protective layers. Descriptions of the acrylic adhesive are the same as described previously.

A backlight is disposed either at the outside of the composite polarizing plate 10 or at the outside of the second polarizing plate 64 when the liquid crystal display device shown in FIG. 6 is used as a transmission type display. The backlight may be disposed at any sides. Accordingly, in a first aspect of the liquid crystal display device, the composite polarizing plate 10 of the invention is disposed at the front side (visual observation side) of the liquid crystal cell 60, and the second retardation film 62 and second polarizing plate 64 are disposed at the rear side (the backlight side in the transmission type). In a second aspect of the liquid crystal display device, the composite polarizing plate 10 is disposed at the rear side of the liquid crystal cell 60, and the second retardation film 62 and second polarizing plate 64 are disposed at the front side. The angle of the axis in each layer is adjusted so that characteristics of the angle of view are optimum in these arrangements.

It is desirable that the adhesive force of the second adhesive layer 17 to the glass of the liquid crystal cell hardly changes with time when the glass of the liquid crystal cell 60 is bonded to the coating retardation film 15 with interposition of the second adhesive layer 17. The adhesive force occurs by allowing an adhesive surface of an adhesive sheet to contact the surface of an object to be adhered, and the method for testing the adhesive force is prescribed in JIS Z0237. The adhesive force tends to be largely decreased with time in the retardation film produced from the coating liquid prepared by mixing the organic modified clay composition having a high content of chlorine and a binder resin with an organic solvent, as compared with the adhesive force immediately after bonding the retardation film to the glass of the liquid crystal cell with interposition of an adhesive. Accordingly, when a retardation film having a low content of chlorine by washing the organic modified clay complex with water immediately after the production thereof is used, the decrease of the adhesive force of the coating retardation film, which is obtained from a coating liquid in which the clay complex described above is blended, with time may be small when the coating retardation film is bonded to the glass of the liquid crystal cell with interposition of the adhesive. Specifically, the adhesive force after storing at 23° C. for 1 month can be maintained at 60% or more, preferably 80% or more, of the adhesive force immediately after bonding, when the coating retardation film is bonded to the glass of the liquid crystal cell with inter position of the adhesive, or when the composite polarizing plate prepared by laminating the coating retardation film with the polarizing plate at the coating retardation film side with interposition of the adhesive.

### EXAMPLE

While the invention is described in detail hereinafter with reference to examples, the invention is by no means restricted to these examples. “%” and “parts” describing the content or amount of use are based on “parts by weight” unless otherwise stated. The materials used for preparing the coating liquid are as follows.

(A) Organic Modified Clay Complex

Trade name “Lucentite STN”: manufactured by CO-OP Chemical Co., a complex of synthetic hectorite and trioctylmethyl ammonium ion

(B) Binder Resin

Trade name “SBU Lacquer 0866”: manufactured by Sumika-Bayer Urethane Co., isophorone diisocyanate -base urethane resin vanish, concentration of solid fraction 30%

The methods for measuring the properties of the sample and evaluation thereof were as follows:

(1) Moisture Content

The moisture content of the coating liquid for coating the retardation film is measured using Karl Fischer moisture meter (trade name KFT Titorino 795, manufactured by Metrohm Co.). A mixed solvent of 55% of chloroform and 45% of ethylene chlorohydrin was used for the measurement.

(2) In-Plane Phase Difference Value R₀

The coating retardation film formed on the transfer base material is transferred to a glass plate with an area of 4 cm square with interposition of an adhesive. The in-plane phase difference value R₀ of the retardation film bonded on the glass plate is measured by a rotary analyzer method with a monochromatic light at a wavelength of 559 nm using an analyzer KOBRA-21ADH (trade name, manufactured by Ohji Scientific Instruments Co.). The in-plane phase difference value R₀ of the retardation film made of a draw resin film is directly measured using KOBRA-21ADH.

(3) Phase Difference Value R′ in the Direction of Thickness

The values of nₓ, n_{y} and n_{z} are determined by the method shown above using the in-plane phase difference value R₀, phase difference value R₄₀ measured at an inclination of 40 degree using the inclined axis as the slow axis, the thickness d of the retardation film and an average refractive index n₀, and the phase difference value R′ in the direction of thickness is calculated from equation (II) above.

(4) Haze Value

The haze value of the coating retardation film formed on a glass plate is measured using haze meter HGM-2DP (trade name, manufactured by Suga Test Instruments Co.).

(5) Contrast

The liquid crystal display device to which a given polarizing plate is attached is adjusted so as to enable black display and white display in combination with a backlight, and the contrast in the nominal line direction of the display face (front contrast) is measured with an angle-dependent luminance meter EZ-Contrast (trade name, manufactured by ELDIM Co.). The contrast is represented by the luminance ratio of the luminance in black display to the luminance in white display.

(6) Adhesive Force

The composite polarizing plate is cut into a width of 25 mm and a length of about 250 mm with the light transmission axis of the polarizer as a principal axis. After bonding the composite polarizing plate onto the glass of the liquid crystal cell, the bonded plate is subjected to a pressurizing treatment in an autoclave at a pressure of 5 kgf/cm² and at a temperature of 50° C. for 20 minutes. Then, the adhesive force is measured at 180° C. at a pulling rate of 300 mm/minute using Autograph AG-1 (trade name, manufactured by Shimadzu Co.).

### Example 1

(a) Production of coating retardation film

| | | |
|---|---|---|
| Urethane resin varnish “SBU lacquer 0866” | 7.5 | parts |
| Organic modified clay complex “Lucentite STN” | 6.8 | parts |
| Toluene | 85.7 | parts |
| Water | 0.2 | parts |

The organic modified clay complex used in this example had been washed with an acid at the manufacturer after producing synthetic hectorite and before modifying with an organic compound, and the clay complex was purchased as an organic modified product. The Mg/Si₄ atomic ratio was 2.68 (measured by the manufacturer). The coating liquid was prepared by mixing the above components in the above-described composition ratio, and was filtered with a membrane filter with a pore diameter of 6 μm after stirring for 360 minutes. The weight ratio of the organic modified clay complex to the urethane resin in the solid fraction was 3/1, and the total solid fraction concentration was 9%. The coating liquid after adding 0.2 parts of water showed a moisture content of 0.27% as measured with a Karl Fischer moisture meter. This coating liquid was applied on a polyethylene terephthalate film (with a water contact angle of 110° on the release-treatment surface) with a thickness of 38 μm after a release treatment using an applicator to obtain a retardation film coated on the film after drying at 50° C. for 1 minute and at 90° C. for 3 minutes. The phase differences R₀ and R′ of the coating retardation film were 0.1 nm and 127 nm, respectively. The haze value of the retardation film coated on a glass plate by the same method as described above was 0.5%.

(b) Production of Composite Polarizing Plate

A semi-finish product comprising the polarizing plate, adhesive layer, coating retardation film and release film was produced by bonding a retardation film (trade name Sumicaran SRW842A, manufactured by Sumitomo Chemical Co.), which has protective layers on both surfaces and an adhesive layer on one surface of a polyvinyl alcohol-base polarizer, onto an exposed surface of the coating layer of the retardation film obtained in (a) above at the adhesive layer side of the polarizing plate. In addition, a polyethylene terephthalate film having a release treatment surface and independently coated with an adhesive was bonded onto the surface of the coating retardation film after releasing the release film to produce a composite polarizing plate comprising the polarizing plate, adhesive layer, coating retardation film, adhesive layer and release film.

(c) Production of Liquid Crystal Display Device and Evaluation thereof

The release film of the composite polarizing plate comprising the polarizing plate, adhesive layer, coating retardation film, adhesive layer and release film obtained in (b) above was peeled, and the composite polarizing plate after peeling the release film was laminated on the upper surface of a VA-type liquid crystal cell (commercially available) with interposition of the exposed adhesive layer of the composite polarizing plate. A second retardation film, which is made of a draw film of cyclic polyolefin with an in-plane phase difference value R₀ of 100 nm and phase difference value R′ in the direction of thickness of 130 nm, was laminated on the lower surface of the liquid crystal cell with interposition of an adhesive. A second polarizing plate (trade name Sumicaran SQ0642A, manufactured by Sumitomo Chemical Co.) having a protective layer on one surface of polyvinyl alcohol/iodine-base polarizer was laminated under the second polarizing plate with interposition of an adhesive so that the lowermost layer on the lower surface serves as a protective layer of the second polarizing plate to manufacture the liquid crystal display device. The composite polarizing plate and second polarizing plate were disposed so that the angle between the absorption axes of the former and latter polarizing plates is 90° and the angle between the slow axes of the former and latter polarizing plates is 90°. The contrast of this liquid crystal display device was measured to be 631.

### Comparative Example 1

(a) Preparation of Coating Retardation Film

The coating liquid was prepared using the following composition:

| | | |
|---|---|---|
| Urethane resin varnish “SBU lacquer 0866” | 7.5 | parts |
| Organic modified clay complex “Lucentite STN” | 6.8 | parts |
| Toluene | 85.7 | parts |

The organic modified clay complex used in this example had not been washed with an acid by the manufacturer after producing synthetic hectorite and before modification with an organic compound, and was commercially available by being modified with the organic compound. The Mg/Si₄ ratio was 2.73 (measured by the manufacturer). A coating liquid was prepared by mixing the components above with the composition above, and was filtered with a membrane filter with a pore size of 6 μm. The coating liquid had a ratio of the organic modified clay complex to the urethane resin of 3/1, and the concentration of the solid fraction was 9%. The moisture content of the coating liquid as measured with a Karl Fischer moisture meter was 0.14%. The coating liquid was applied on a polyethylene terephthalate film with a thickness of 38 μm subjected to a release treatment under the same condition as in Example 1, and a retardation film coated on the film was obtained. The phase differences R₀ and R′ of the coating retardation film were measured to be 0.1 nm and 126 nm, respectively. The haze value of the retardation film coated on a glass plate was 2.8%.

(b) Preparation of Composite Retardation Film

A semi-finish product comprising the polarizing plate, adhesive layer, coating retardation film and release film was produced by the same method as in (b) of Example 1 using the retardation film obtained in (a) above. A composite polarizing plate comprising the polarizing plate, adhesive layer, coating retardation film, adhesive layer and release film was separately produced.

(c) Production of Liquid Crystal Display Device and Evaluation thereof

A liquid crystal display device was produced by the same method as in (c) of Example 1 using the composite polarizing plate comprising the polarizing plate, adhesive layer, coating retardation film, adhesive layer and release film obtained in (b) above. The contrast of this liquid crystal display device was measured to be 604.

### Example 2

(a) Production of Coating Rretardation Film

The coating liquid was prepared using the following composition:

| | | |
|---|---|---|
| Urethane resin varnish “SBU lacquer 0866” | 16.0 | parts |
| Organic modified clay complex “Lucentite STN” | 7.2 | parts |
| Toluene | 76.8 | parts |
| Water | 0.3 | parts |

The organic modified clay complex used in this example was available by washing with water after producing synthetic hectorite and before modifying with an organic compound. Synthetic hectorite was modified with the organic compound, and washed with water by the manufacturer. The content of chlorine in the modified clay complex was 1,257 ppm, and the Mg/Si₄ atomic ratio was 2.68 (measured by the manufacturer). The composition above was mixed and stirred for 360 minutes, and the coating liquid obtained was filtered with a membrane filter with a pore size of 6 μm. The weight ratio of the organic modified clay complex to the urethane resin in the solid fraction of this coating liquid was 1.5/1, and the concentration of the solid fraction was 12%. The moisture content of the coating liquid after adding 0.3 parts of water as measured with a Karl Fischer moisture meter was 0.27%. This coating liquid was applied on a polyethylene terephthalate film (water contact angle 110° after the release treatment) subjected to a release treatment and having a thickness of 38 μm using an applicator, and a retardation film coated on a film was obtained by drying at 50° C. for 1 minute and at 90° C. for 3 minutes. The phase differences R₀ and R′ of this coating retardation film were measured to be 0 nm and 151 nm, respectively. The haze value of the retardation film coated on a glass plate was 0.3%.

(b) Production of Composite Polarizing Plate

A semi-finish product comprising the polarizing plate, adhesive layer, coating retardation film and release film was produced by bonding a retardation film (trade name Sumicaran SRW842A, manufactured by Sumitomo Chemical Co.), which has protective layers on both surfaces and an adhesive layer on one surface of a polyvinyl alcohol/chlorine base polarizer, onto an exposed surface of the coating layer of the retardation film obtained in (a) above at the adhesive layer side of the polarizing plate. In addition, a polyethylene terephthalate film having a release treatment surface independently coated with an adhesive was bonded onto the surface of the coating retardation film after releasing the release film to produce a composite polarizing plate comprising the polarizing plate, adhesive layer, coating retardation film, adhesive layer and release film.

(c) Production of Liquid Crystal Display Device and Evaluation thereof

The release film of the composite polarizing plate comprising the polarizing plate, adhesive layer, coating retardation film, adhesive layer and release film obtained in (b) above was peeled, and the composite polarizing plate after peeling the release film was laminated on the upper surface of a VA-type liquid crystal cell (commercially available) with interposition of the exposed adhesive layer of the composite polarizing plate. A second retardation film, which is made of a draw film of cyclic polyolefin with an in-plane phase difference value R₀ of 100 nm and phase difference value R′ in the direction of thickness of 130 nm, was laminated on the lower surface of the liquid crystal cell with interposition of an adhesive. A second polarizing plate (trade name Sumicaran SQ0642A, manufactured by Sumitomo Chemical Co.) having a protective layer on one surface of polyvinyl alcohol/iodine-base polarizer was laminated under the second polarizing plate with interposition of an adhesive so that the lowermost layer on the lower surface serves as a protective layer of the second polarizing plate to manufacture the liquid crystal display device. The composite polarizing plate and second polarizing plate were disposed so that the angle between the absorption axes of the composite polarizing plate and second polarizing plate is 90° and the angle between absorption axis of the second polarizing plate and slow axes of the second retardation film is 90°. The contrast of this liquid crystal display device was measured to be 641. The adhesive force of the composite polarizing plate on the upper surface of the liquid crystal display device immediately after bonding was 6.34 N/25 mm, and the adhesive force after preservation at 23° C. for 1 week and the adhesive force after preserving at the same temperature for 1 month were 7.13 N/25 mm and 8.05 N/25 mm, respectively. The adhesion after preserving at 23° C. for 1 week and for 1 month were rather increased as compared with the adhesive force of the composite polarizing plate immediately after bonding.

### Example 3

(a) Production of Coating Retardation Film

The coating liquid was prepared using the composition below:

| | | |
|---|---|---|
| Urethane resin varnish “SBU lacquer 0866” | 16.0 | parts |
| Organic modified clay complex “Lucentite STN” | 7.2 | parts |
| Toluene | 76.8 | parts |
| Water | 0.3 | parts |

The organic modified clay complex used in this example had been washed with an acid by the manufacturer after producing synthetic hectorite and before modification with an organic compound, and was commercially available by being modified with the organic compound followed by washing with water. The chlorine content was 1,659 ppm, and Mg/Si₄ ratio was 2.68 (measured by the manufacturer). A coating liquid was prepared by mixing the components above with the composition above, and was filtered with a membrane filter with a pore size of 6 μm after stirring for 360 minutes. The coating liquid had a ratio of the organic modified clay complex to the urethane resin of 1.5/1, and the concentration of the solid fraction was 12%. The moisture content of the coating liquid as measured with a Karl Fischer moisture meter was 0.27% after adding 0.3 parts of water. The coating liquid was applied on a polyethylene terephthalate film with a thickness of 38 μm subjected to a release treatment under the same condition as in Example 2, and a retardation film coated on the film was obtained after drying. The phase differences R₀ and R′ of the coating retardation film were measured to be 0 nm and 133 nm, respectively. The haze value of the retardation film coated on a glass plate was 0.3%.

(b) Preparation of Composite Retardation Film

A semi-finish product comprising the polarizing plate, adhesive layer, coating retardation film and release film was produced by the same method as in (b) of Example 2 using the retardation film obtained in (a) above. A composite polarizing plate comprising the polarizing plate, adhesive layer, coating retardation film, adhesive layer and release film was also produced.

(c) Production of Liquid Crystal Display Device and Evaluation thereof

A liquid crystal display device was produced by the same method as in (c) of Example 2 using the composite polarizing plate comprising the polarizing plate, adhesive layer, coating retardation film, adhesive layer and release film obtained in (b) above. The contrast of this liquid crystal display device was measured to be 652. The adhesive force of the composite polarizing plate on the upper surface of the liquid crystal display device immediately after bonding was 8.10 N/25 mm, and the adhesive force after preservation at 23° C. for 1 week and the adhesive force after preserving at the same temperature for 1 month were 7.76 N/25 mm and 7.46 N/25 mm, respectively. The adhesion after preserving at 23° C. for 1 week and for 1 month were 96% and 92%, respectively, of the adhesive force of the composite polarizing plate immediately after bonding.

### Comparative Example 2

(a) Preparation of Coating Retardation Film

The coating liquid was prepared using the following composition:

| | | |
|---|---|---|
| Urethane resin varnish “SBU lacquer 0866” | 16.0 | parts |
| Organic modified clay complex “Lucentite STN” | 7.2 | parts |
| Toluene | 76.8 | parts |

The organic modified clay complex used in this example was the same as used in Example 2, and the chlorine content was 1,257 ppm and the Mg/Si₄ ratio was 2.68 (measured by the manufacturer). A coating liquid was prepared by mixing the components above with the composition above, and was filtered with a membrane filter with a pore size of 6 μm after stirring for 360 minutes. The coating liquid had a ratio of the organic modified clay complex to the urethane resin of 1.5/1, and the concentration of the solid fraction was 12%. The moisture content of the coating liquid as measured with a Karl Fischer moisture meter was 0.11%. The coating liquid was applied on a polyethylene terephthalate film with a thickness of 38 μm subjected to a release treatment under the same condition as in Example 2, and a retardation film coated on the film was obtained. The phase differences R₀ and R′ of the coating retardation film were measured to be 0 nm and 111 nm, respectively. The haze value of the retardation film coated on a glass plate was 3.7%.

(b) Preparation of Composite Retardation Film

A semi-finish product comprising the polarizing plate, adhesive layer, coating retardation film and release film was produced by the same method as in (b) of Example 2 using the retardation film obtained in (a) above. A composite polarizing plate comprising the polarizing plate, adhesive layer, coating retardation film, adhesive layer and release film was also produced.

(c) Production of Liquid Crystal Display Device and Evaluation thereof

A liquid crystal display device was produced by the same method as in (c) of Example 2 using the composite polarizing plate comprising the polarizing plate, adhesive layer, coating retardation film, adhesive layer and release film obtained in (b) above. The contrast of this liquid crystal display device was measured to be 592. The adhesive force of the composite polarizing plate on the upper surface of the liquid crystal display device immediately after bonding was 12.43 N/25 mm, and the adhesive force after preservation at 23° C. for 1 week and the adhesive force after preserving at the same temperature for 1 month were 11.12 N/25 mm and 10.24 N/25 mm, respectively. The haze value of the coating retardation film was high because the moisture content of the coating liquid was not adjusted, and the contrast of the liquid crystal display device produced using this coating liquid was low. On the other hand, the adhesion after preserving at 23° C. for 1 week and for 1 month were maintained at high levels as compared with the adhesive force immediately after bonding, since the organic modified clay complex having low chlorine content was used.

The composite polarizing plate comprising the retardation film according to the invention laminated on the polarizing plate can be effectively used for improving characteristics of the angle of view in various modes of liquid crystal display device such as vertical orientation (VA) as well as twisted nematic (TN) mode and optical compensation in the bend orientation mode (OCB) liquid crystal display devices.

1. A coating liquid for coating a retardation film comprising an organic modified clay complex and a binder resin in an organic solvent, characterized by said coating liquid having a moisture content in the range from 0.15 to 0.35% by weight as measured with a Karl Fischer moisture meter.

2. The coating liquid for coating the retardation film according to claim 1, wherein the weight ratio of the organic modified clay complex to the binder resin in the range from exceeding 0.5 to 3 or less.

3. The coating liquid for coating the retardation film according to claim 1, wherein the binder resin is an isophorone diisocyanate base urethane resin.

4. The coating liquid for coating the retardation film according to claim 1, wherein the organic modified clay complex is a complex of a quaternary ammonium compound having alkyl groups with a carbon number of 1 to 30 and a clay mineral belonging to smectite group.

5. The coating liquid for coating the retardation film according to claim 1, wherein the organic modified clay complex is a complex of an organic and a clay mineral belonging to smectite group, and the atomic ratio (Mg/Si₄) of four silicon atoms to magnesium atoms is less than 2.73.

6. The coating liquid for coating the retardation film according to claim 1, wherein the chlorine content in the organic modified clay complex is reduced to 2,000 ppm or less.

7. A retardation film characterized by forming a film of a composition obtained by removing the organic solvent and water from the coating liquid for coating the retardation film according to claim 1.

8. The retardation film according to claim 7 having a haze value of 0.6% or less.

9. The retardation film according to claim 7 having an in-plane phase difference in the range from 0 to 10 nm and a phase difference in the direction of thickness in the range from 40 to 350.

10. A method for producing a retardation film characterized by applying a coating liquid comprising an organic modified clay complex, a binder resin, an organic solvent and water and having a moisture content in the range from 0.15 to 0.35% by weight on a base material, and then removing the organic solvent and water.

11. A composite polarizing plate characterized by prepared by laminating a polarizing plate, an adhesive layer and the retardation film according to claim 7.

12. The composite polarizing plate according to claim 11 comprising a second adhesive layer further formed at the outside of the retardation film.

13. A method for producing a composite retardation film laminating a polarizing plate, an adhesive layer and a retardation film laminated in this order,
said method comprising the steps of: applying a coating liquid containing an organic modified clay complex and a binder resin in an organic solvent and having a moisture content in the range from 0.15 to 0.35% as measured with a Karl Fischer moisture meter on a transfer base material; forming a coating retardation film by removing the organic solvent and water from the coating liquid; bonding an exposed surface of the coating retardation film at the adhesive layer side of the polarizing plate having said adhesive layer; and peeling the transfer base material from the coating retardation film.

14. A liquid crystal display device comprising: a liquid crystal cell; the composite polarizing plate according to claim 11 disposed on one surface of the liquid crystal cell so that the retardation film rather than the polarizing plate comes to the liquid crystal cell side; a second retardation film disposed on another surface of the liquid crystal cell, said second retardation film having an in-plane phase difference value R₀ in the range from 30 to 300 nm, and a ratio R₀/R′ of the in-plane phase difference value R₀ to a phase difference value R′ in the direction of thickness in the range from exceeding o to less than 2; and a second polarizing plate disposed to the side of the liquid crystal cell opposite to the second retardation film.
